(19) United States
(12) Patent Application Publication
(10) Pub. No.: US 2016/0042557 A1
(43) Pub. Date: Feb. 11, 2016

(54) METHOD OF APPLYING VIRTUAL MAKEUP, VIRTUAL MAKEUP ELECTRONIC SYSTEM, AND ELECTRONIC DEVICE HAVING VIRTUAL MAKEUP ELECTRONIC SYSTEM

(71) Applicant: ASUSTeK COMPUTER INC., Taipei City (TW)

(72) Inventors: Wei-Po Lin, Taipei City (TW); Yi-Chi Cheng, Taipei City (TW); Keng-Te Liao, Taipei City (TW)

(21) Appl. No.: 14/819,426

(22) Filed: Aug. 6, 2015

Related U.S. Application Data
(60) Provisional application No. 62/034,800, filed on Aug. 8, 2014.

(30) Foreign Application Priority Data
Jun. 17, 2015 (TW) 104119554

(51) Int. Cl. G06T 15/50; G06T 19/00; A45D 44/00; G06T 5/50; G06T 17/20; G06T 15/80; G06T 19/20

(52) U.S. Cl. CPC G06T 15/506; G06T 15/80; G06T 19/006; G06T 19/20; G06T 5/50; G06T 17/20; A45D 44/005; G06T 2207/10016

(57) ABSTRACT

A method of applying virtual makeup adapted for an electronic device having a virtual makeup electronic system is provided. The method of applying virtual makeup includes the steps: receiving a plurality of facial images of different angles of a face to construct a 3D facial model; recording a real-time facial image of the face, and the 3D facial model varies with the face in real time according to the real-time facial image; providing 3D virtual makeup to the 3D facial model; converting the 3D virtual makeup to 2D virtual makeup according to a position and an angle of the real-time facial image; combining the real-time facial image and the 2D virtual makeup to generate an output image; and displaying the output image. A virtual makeup electronic system and an electronic device having a virtual makeup electronic system are further provided.

### CROSS-REFERENCE TO RELATED APPLICATION

This application claims the priority benefits of U.S. provisional application Ser. No. 62/034,800, filed on Aug. 8, 2014 and TW application serial No. 104119554, filed on Jun. 17, 2015. The entirety of each of the above-mentioned patent applications is hereby incorporated by reference herein and made a part of specification.

### BACKGROUND OF THE INVENTION

1. Field of the Invention

The invention relates to a method of applying virtual makeup, a virtual makeup electronic system and an electronic device having the virtual makeup electronic system and, more particularly, to a method of applying virtual makeup in real time, a real-time virtual makeup electronic system and a real-time electronic device having the virtual makeup electronic system.

2. Description of the Related Art

Conventionally, a method of applying virtual makeup on a face image usually searches feature points (such as eyes, lips) at a two dimension (2D) image of a face, and then the virtual makeup (such as virtual eye shadow, virtual lipstick) is provided at a corresponding position of the 2D image.

However, when a user turns or moves his/her head, or when certain facial characters are covered, the feature points are not easily been found correctly. Then, the virtual makeup is failed to apply or applied to inappropriate positions. Consequently, since a conventional virtual makeup method has a fixed shape and size for a face image, the virtual makeup effect is in a proper manner when a user faces right to a camera with a frontal view. However, if the user does not show the face right to a camera, the virtual makeup process is not properly performed since the fixed shape and size cannot be changed accordingly.

### BRIEF SUMMARY OF THE INVENTION

A method of applying virtual makeup is provided, and a shape, a size and a position of the virtual makeup are adjusted with the moving or turning of a face in real time.

A virtual makeup electronic system is provided, and suitable virtual makeup is provided to along with a face in moving or turning in real time.

An electronic device having a virtual makeup electronic system is provided, and suitable virtual makeup is provided and displayed along with the moving or turning of a face in real time.

A method of applying virtual makeup applied to an electronic device is provided. The method of applying virtual makeup includes the steps: obtaining a plurality of facial images of different angles of a face to construct a three dimensional (3D) facial model corresponding to the face; recording a real-time facial image of the face, and the 3D facial model varies with the face in real time according to a position and an angle of the real-time facial image; providing 3D virtual makeup to the 3D facial model; converting the 3D virtual makeup to two dimension (2D) virtual makeup according to the position and the angle of the real-time facial image; combining the real-time facial image and the 2D virtual makeup to generate an output image; and displaying the output image.

A virtual makeup electronic system applied to an electronic device is provided. The virtual makeup electronic system includes an image receiving unit, a 3D facial model constructing unit, a 3D facial model moving unit, a makeup information receiving unit, a virtual makeup unit and a data processing unit. The image receiving unit receives a plurality of facial images of different angles of a face and a real-time facial image of the face. The 3D facial model constructing unit is coupled to the image receiving unit, and the 3D facial model constructing unit constructs a 3D facial model via the facial images. The 3D facial model moving unit is coupled to the image receiving unit and the 3D facial model constructing unit, and the 3D facial model moving unit changes a position and an angle of the 3D facial model according to a position and an angle of the real-time facial image. The makeup information receiving unit receives makeup information. The virtual makeup unit is coupled to the 3D facial model constructing unit, the 3D facial model moving unit and the makeup information receiving unit, and the virtual makeup unit provides 3D virtual makeup to the 3D facial model according to the makeup information. The data processing unit is coupled to the image receiving unit and the virtual makeup unit, the data processing unit converts the 3D virtual makeup to 2D virtual makeup according to the position and the angle of the real-time facial image, and the real-time facial image and the 2D virtual makeup are combined to generate an output image.

An electronic device having a virtual makeup electronic system is provided. The electronic device includes an image capture module, a processing module and a display screen. The image capture module captures a real-time facial image of a face. The processing module is electrically connected to the image capture module, and the processing module constructs a 3D facial model via a plurality of facial images of different angles of the face. The processing module makes the 3D facial model vary with the face in real time according to the real-time facial image. The processing module provides 3D virtual makeup to the 3D facial model according to a position and an angle of the real-time facial image, and the processing module converts the 3D virtual makeup to 2D virtual makeup and combines the real-time facial image and the 2D virtual makeup to generate an output image. The display screen is electrically connected to the processing module, and the display screen displays the output image.

In sum, the method of applying virtual makeup and the electronic device having the virtual makeup electronic system construct the 3D facial model via the facial images of different angles, and the 3D facial model varies with the face in real time. The processing unit provides the 3D virtual makeup to the 3D facial model, and the processing unit converts the 3D virtual makeup to the 2D virtual makeup according to the position and the angle of the real-time facial image (such as the angle between the image capture module and the face). The position, the shape, the size and the angle of the 2D virtual makeup change according to the real-time facial image (the face is in moving or turning). The real-time facial image and the 2D virtual makeup are combined to generate the output image. The display module displays the output image. Consequently, even if the face turns to some angles where the feature points of the real-time facial image are different from that of the frontal view of a face (for example, when the face turns 60°, the size and the distance of the eyes are changed) or part of the feature points are covered, the output image still has the 2D virtual makeup which is similar to the actual makeup, and the output image looks more natural.

### BRIEF DESCRIPTION OF THE DRAWINGS

These and other features, aspects and advantages of the invention will become better understood with regard to the following embodiments and accompanying drawings.

FIG. 1 is a flow chart showing a method of applying virtual makeup in an embodiment;

FIG. 2 is a schematic diagram showing an electronic device having a virtual makeup electronic system in an embodiment;

FIG. 3A and FIG. 4A are schematic diagrams showing a real-time facial image in an embodiment, respectively;

FIG. 3B and FIG. 4B are schematic diagrams showing a 3D facial model constructed according to FIG. 3A and FIG. 4A, respectively;

FIG. 3C and FIG. 4C are schematic diagrams showing a 3D facial model and 3D virtual makeup applied to the 3D facial model, respectively;

FIG. 3D and FIG. 4D are schematic diagrams showing 2D virtual makeup converted from the 3D virtual makeup in FIG. 3C and FIG. 4C, respectively;

FIG. 3E and FIG. 4E are schematic diagrams showing an output images by combining a real-time facial image and 2D virtual makeup, respectively; and

FIG. 5 is a schematic diagram showing a virtual makeup electronic system in an embodiment.

### DETAILED DESCRIPTION OF THE EMBODIMENTS

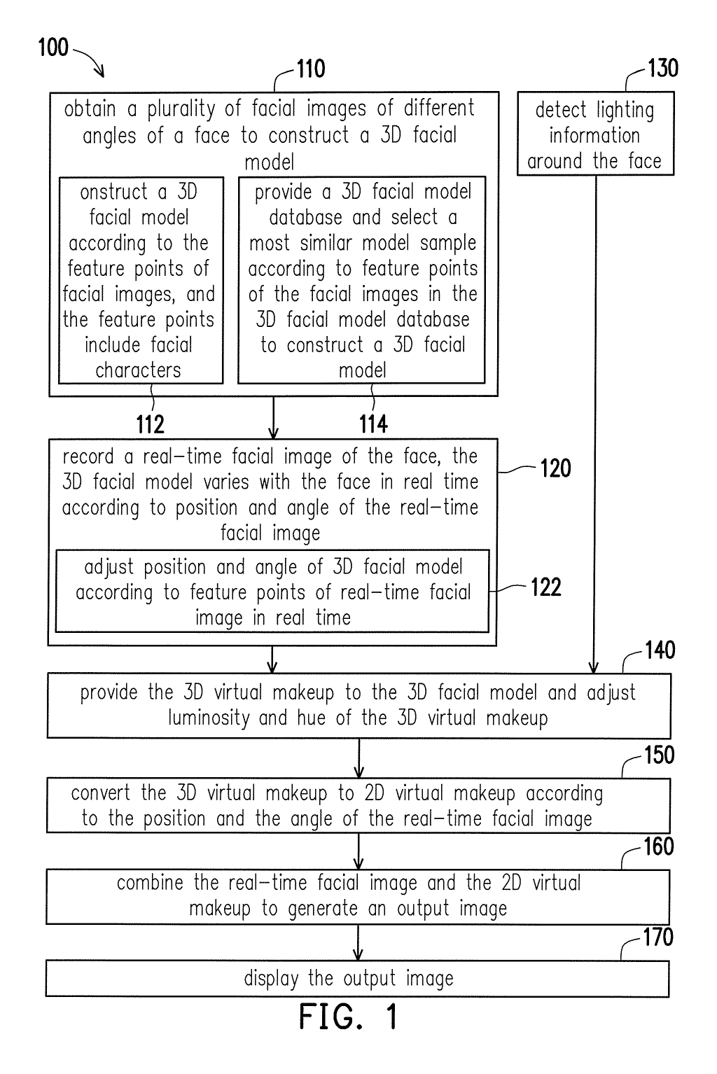

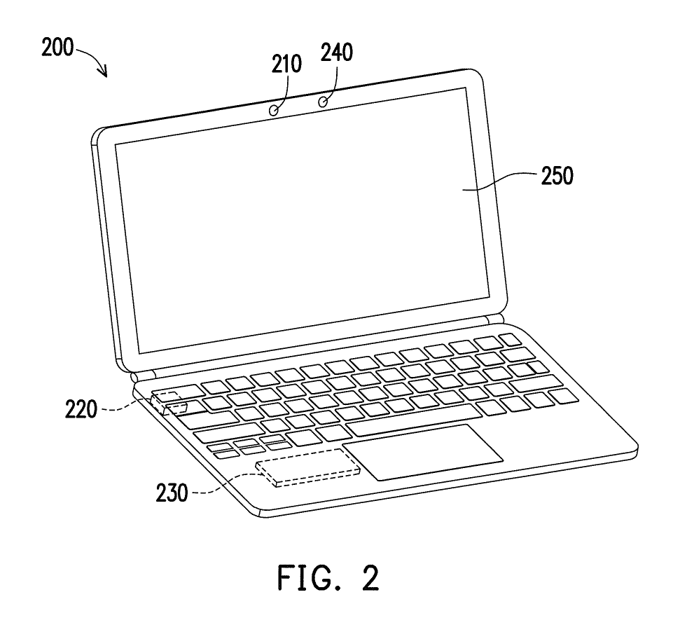

FIG. 1 is a flow chart showing a method of applying virtual makeup in an embodiment. FIG. 2 is a schematic diagram showing an electronic device having a virtual makeup electronic system in an embodiment. Please refer to FIG. 1 and FIG. 2, in the embodiment, a method of applying virtual makeup 100 provides two dimensional (2D) virtual makeup to a user's facial image in real time via an electronic device 200 having a virtual makeup electronic system in FIG. 2. As shown in FIG. 2, the electronic device 200 is a notebook computer, in other embodiments, it is a desktop computer, a tablet computer or an electronic device with a virtual makeup function, which is not limited herein.

In the embodiment, the electronic device 200 having the virtual makeup electronic system includes an image capture module 210, a processing module 220, a storage module 230 and a display screen 250. In an embodiment, the image capture module 210 is a camera of a notebook computer, the processing module 220 is a central process unit (CPU), and the storage module 230 is a hard disc, compact disk, or a flash drive, which is not limited herein. The image capture module 210, the storage module 230 and the display screen 250 are electrically connected to the processing module 220, respectively.

In the embodiment, the method of applying virtual makeup 100 includes the following steps. A plurality of facial images of different angles of a face are obtained to construct a three dimensional (3D) facial model (step 110). In the embodiment, the user turns his or her face to different angles in front of an image capture module 210 to take multiple facial images of different angles. The image capture module 210 is a 2D image capture module or a 3D image capture module, which is used to capture a 2D image or a 3D image. In an embodiment, the facial images are captured by one or a plurality of lens and input to the electronic device 200 having the virtual makeup electronic system.

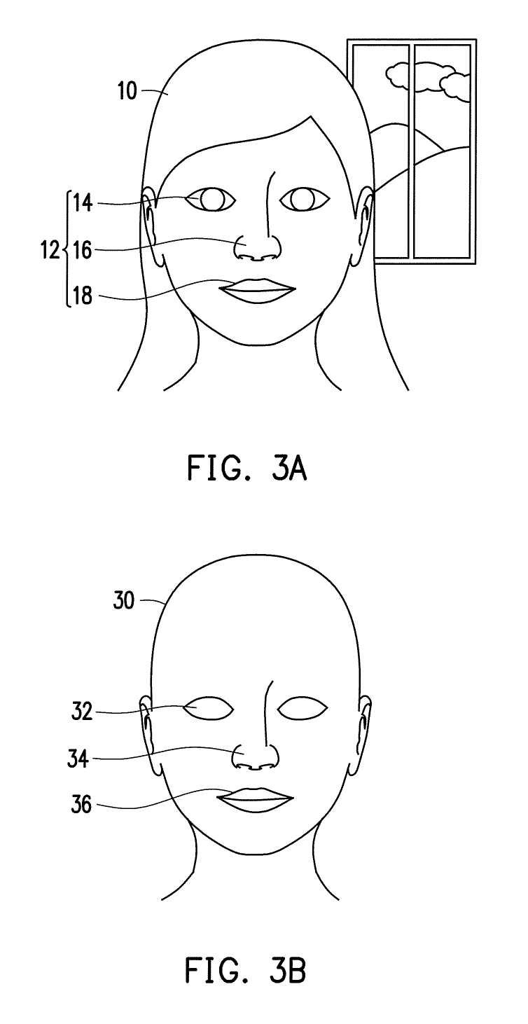

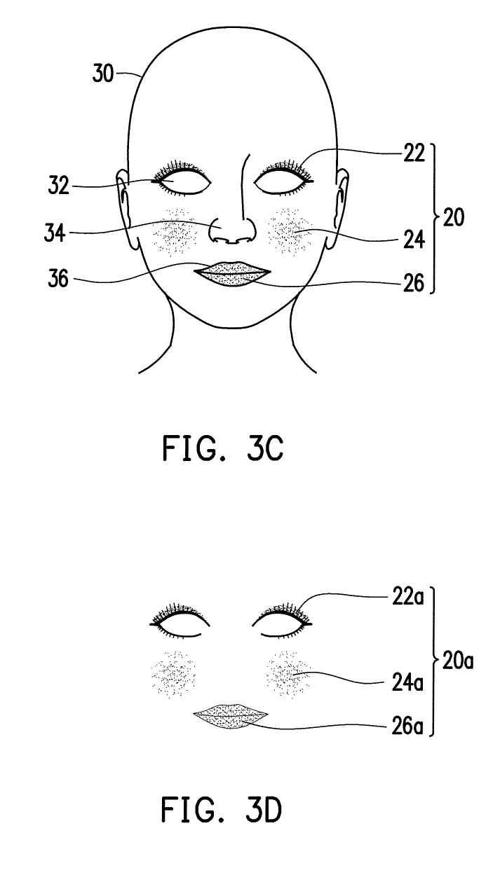

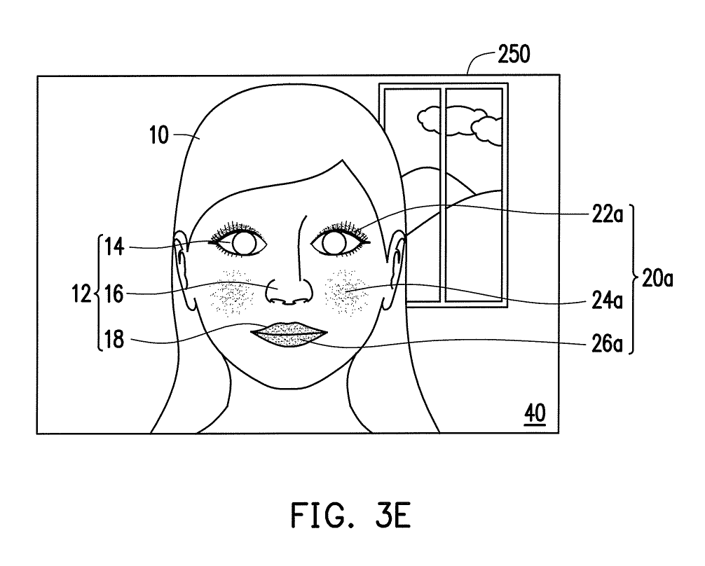

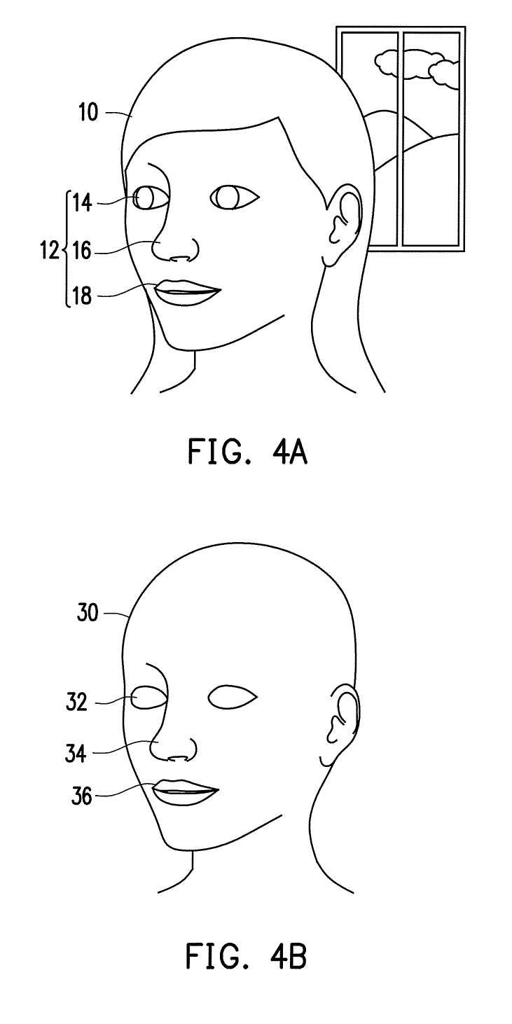

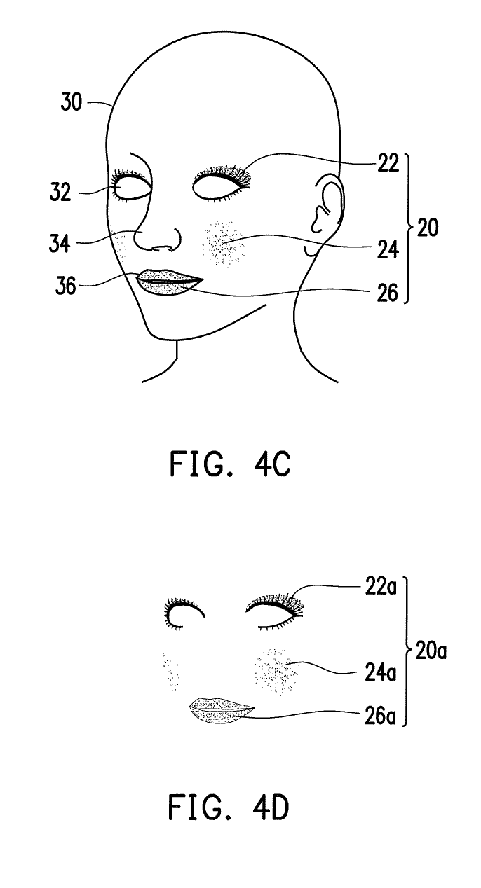

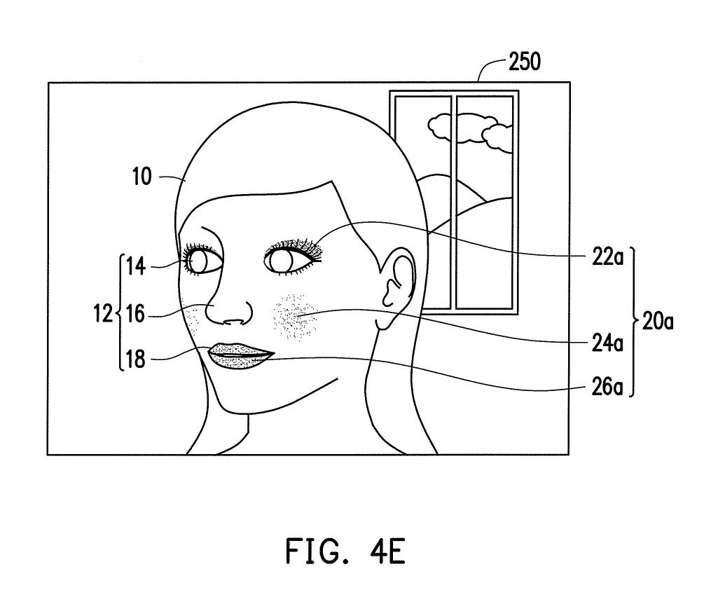

In the embodiment, the processing module 220 constructs a 3D facial model 30 (shown in FIG. 3C and FIG. 4C) according to a plurality of feature points 12 (shown in FIG. 3A to FIG. 4B) of the facial images, and the feature points 12 include facial characters (step 112). In an embodiment, the processing module 220 recognizes the facial characters of the facial images, such as the character of eyes 14 (shown in FIG. 3A to FIG. 4A), a nose 16 (shown in FIG. 3A to FIG. 4A), a mouth 18 (shown in FIG. 3A to FIG. 4A), an ear or a facial curve, which is not limited herein. In an embodiment, the character of the eyebrow (not shown) is also recognized by the processing module 220. After the processing module 220 recognizes the facial characters, a virtual face model is constructed by computing a distance between the eyebrow and the eye, a distance between the two eyes or a width of the mouth, which is not limited herein. In the embodiment, the processing module 220 compares the feature points 12 of many real-time facial images 10 at different angles, so as to construct a 3D facial model 30 which is much similar to the face. After the 3D facial model 30 is constructed, the 3D facial model 30 is stored in the storage module 230.

In an embodiment, a method of fast constructing the 3D facial model 30 is provided. As shown in step 114, a storage device 230 stores a 3D facial model database, and the 3D facial model database collects numerous (ex. hundreds) of the 3D facial models. When the processing module 220 analyzes the real-time facial images 10, the processing module 220 selects a most similar model sample in the 3D facial model database to apply directly according to the information of the main feature points 12 (which are set manually by the user) of the real-time facial images 10, the 3D facial model 30 is thus constructed (step 114). In the embodiment, in the step 114, the processing program of the processing module 220 is simplified, the same 3D facial model 30 can be used by different users who have similar facial characters, and the efficiency is thus improved.

Further, a real-time facial image 10 of the face is recorded, and the 3D facial model 30 varies with the change of the face in real time according to a position and an angle of the real-time facial image 10 (step 120). In the embodiment, the image capture module 210 captures an image of the user in front of the image capture module 210 in real time to obtain the real-time facial images 10. The processing module 220 analyzes the feature points of each of the real-time facial images 10 continuously to adjust the position and the angle of the 3D facial model 30 in real time (step 122). As a result, the 3D facial model 30 varies with moving of the face in real time. FIG. 3A and FIG. 4A are schematic diagrams showing a real-time facial image in an embodiment, respectively. FIG. 3B and FIG. 4B are schematic diagrams showing a 3D facial model 30 constructed according to FIG. 3A and FIG. 4A, respectively. As shown in FIG. 3A and FIG. 4A, the 3D facial model 30 varies with the face in real time according to the position and the angle of the real-time facial image 10.

In the embodiment, when the user in front of the image capture module 210 turns the face, the image capture module 210 captures the real-time facial images 10 of different time sequences. Since the real-time facial images 10 of different time sequences are different (for example, the user turns the face or leans the head) and the 2D virtual makeup 20a (shown in FIG. 3E and FIG. 4E) corresponding to the real-time facial images 10 of different time sequences are also different, the 2D virtual makeup 20a looks natural. In detail, in FIG. 4A, an area value of cheeks and a shape of eyes of the real-time facial images 10 of a profile face are different, a position of facial characters in FIG. 4A is also different from that of the real-time facial image 10 of a frontal face in FIG. 3A, then, a shape and the scope of the 2D virtual makeup 20a to be applied to the real-time facial image 10 change accordingly. In the embodiment, the 3D facial model 30 varies with the moving of the face in real time to provide natural makeup to the real-time facial image 10.

Moreover, since surrounding light performance affects the 2D virtual makeup 20a (shown in FIG. 3D, FIG. 3E, FIG. 4D and FIG. 4E), in the embodiment, to make the final 2D virtual makeup 20a of the output image 40 displays more natural hue and shadow, the electronic device 200 having the virtual makeup electronic system further includes a sensor module 240. The sensor module 240 is electrically connected to the processing module 220. In an embodiment, the sensor module 240 is built in or externally connected to a notebook computer. The sensor module 240 detects lighting information around the face (step 130). In the embodiment, the lighting information includes intensity and a direction of the light.

FIG. 3C and FIG. 4C are schematic diagrams showing a 3D facial model 30 and the 3D virtual makeup 20 applied to the 3D facial model 30, respectively. Please refer to FIG. 3C and FIG. 4C, the processing module 220 provides 3D virtual makeup 20 to the 3D facial model according to an instruction of the user and adjusts luminosity and hue of the 3D virtual makeup 20 according to the lighting information (step 140). In the embodiment, the 3D virtual makeup 20 includes 3D virtual eye makeup 22, 3D virtual blusher 24 and 3D virtual lip makeup 26, which is not limited herein.

In the embodiment, the sensor module 240 detects the lighting information around the face when the image capture module 210 captures the image of the face, and the processing module 220 adjusts the luminosity and the shadow of the 3D virtual makeup 20 according to the received lighting information, so as to get a natural effect. In an embodiment, when the light performance around the user is strong, the hue of the 3D virtual makeup 20 is lighter accordingly. In an embodiment, when the light illuminates on the user from left to right, the left face looks brighter than the right face, and then brightness and hue of the 3D virtual makeup 20 of the 3D facial model 30 at different parts are adjusted accordingly.

FIG. 3D and FIG. 4D are schematic diagrams showing the 2D virtual makeup 20a converted from the 3D virtual makeup 20 in FIG. 3C and FIG. 4C, respectively. Please refer to FIG. 3D and FIG. 4D, the processing module 220 converts the 3D virtual makeup 20 to the 2D virtual makeup 20a according to the position and the angle of the real-time facial image 10 (step 150). FIG. 3E and FIG. 4E are schematic diagrams showing an output image 40 by combining the real-time facial image 10 and the 2D virtual makeup 20a, respectively. Please refer to FIG. 3E and FIG. 4E, the processing module 220 combines the real-time facial image 10 and the 2D virtual makeup 20a to generate an output image 40 (step 160). The display screen 250 displays the output image 40 (step 170). In the embodiment, the output image 40 combining the real-time facial image 10 and the virtual makeup 20 is output to the display screen 250, and then the user sees the output image 40 having the 2D virtual makeup 20a at the display screen 250 directly. If the user has a video chat online with other people, the user looks like wear makeup shown by the display screen 250.

In the embodiment, since the processing module 220 provides the 3D virtual makeup 20 to the 3D facial model 30, and then the processing module 220 converts the 3D virtual makeup 20 to the 2D virtual makeup 20a according to the position and the angle of the real-time facial image 10 (such as the angle between the image capture module 210 and the face). Thus, even if the face turns to some angles where the feature points 12 of the real-time facial image 10 are different from that of the frontal face or part of the feature points 12 are covered, the output image 40 still has the suitable 2D virtual makeup 20a. In other words, the position, the shape, the size, the angle, the luminosity and the shadow of the 2D virtual makeup 20a vary with the moving or turning of the face, and then the 2D virtual makeup 20a of the output image 40 displayed at the display screen 250 looks more natural.

Further, in FIG. 4E, the range of the area value and the shape of the 2D virtual eye makeup 22a and the 2D virtual blusher 24a vary with the area value of cheeks and the shape of the eyes of the real-time facial image 10. As shown in FIG. 4E, the area of the 2D virtual eye makeup 22a and the 2D virtual blusher 24a in the left side is reduced accordingly, which avoids that the 2D virtual eye makeup 22a and the 2D virtual blusher 24a exceed the position of the eyes and the cheeks on the real-time facial image 10.

Compared FIG. 3E to FIG. 4E, the angles of eyelashes of the 2D virtual eye makeup 22a changes with the varying of the angles of the real-time facial images 10. As a result, no matter how the face turns, the 2D virtual eye makeup 22a looks like the realistic eye makeup, the eyelashes of the frontal face would not be displayed at the real-time facial image 10 of the profile face, and the 2D virtual eye makeup 22a would not disappear at the profile face. In other words, in the embodiment, the processing module 220 provides the 2D virtual makeup 20a suitable to the real-time facial image 10 according to the position and the angle of the 3D facial models 30 of different time sequences.

A virtual makeup electronic system 300 is provided, which is executed by an electronic device (such as the electronic device shown in FIG. 2), and in an embodiment, the electronic device is a notebook computer, a desktop computer, a tablet computer or an electronic device providing a virtual makeup function, which is not limited herein.

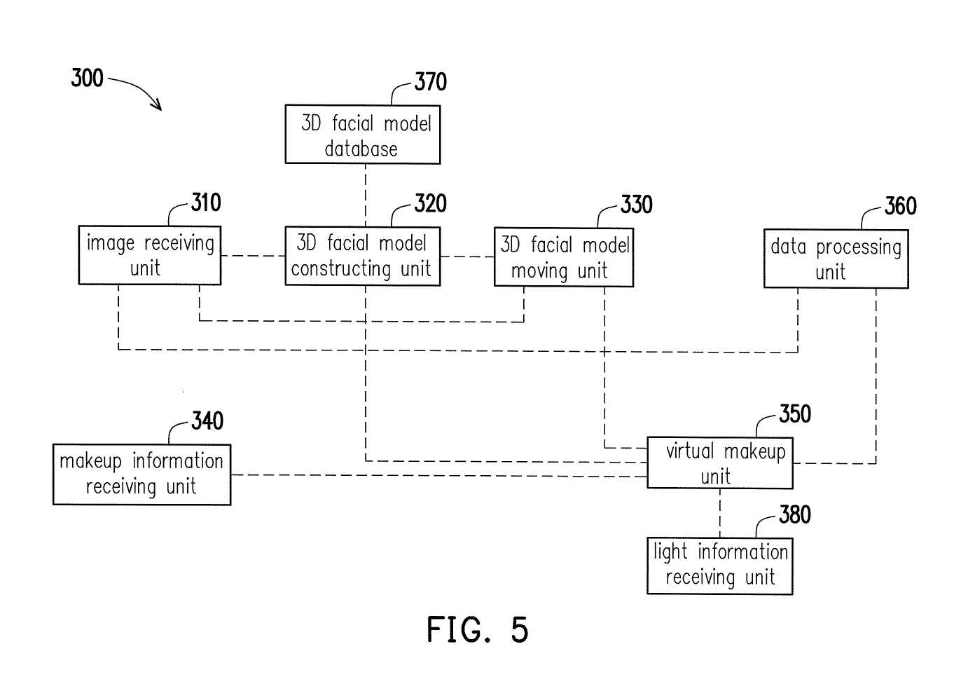

FIG. 5 is a schematic diagram showing a virtual makeup electronic system in an embodiment. Please refer to FIG. 5, in the embodiment, the virtual makeup electronic system 300 includes an image receiving unit 310, a 3D facial model constructing unit 320, a 3D facial model moving unit 330, a makeup information receiving unit 340, a virtual makeup unit 350 and a data processing unit 360.

In the embodiment, the image receiving unit 310 receives a plurality of facial images of different angles and a real-time facial image. The makeup information receiving unit 340 receives makeup information. The image receiving unit 310 and the makeup information receiving unit 340 are different components in FIG. 5. In an embodiment, the image receiving unit 310 and the makeup information receiving unit 340 are intergrade to a same receiving unit.

The 3D facial model constructing unit 320 is coupled to the image receiving unit 310, and the 3D facial model constructing unit 320 utilize the facial images to construct a 3D facial model. In the embodiment, the virtual makeup electronic system 300 further includes a 3D facial model database 370 which is coupled to the 3D facial model constructing unit 320. The 3D facial model constructing unit 320 selects a most similar model sample in the 3D facial model database 370 to apply directly according to a plurality of feature points of facial images, the suitable 3D facial model is constructed. In an embodiment, the 3D facial model database 370 is omitted in the virtual makeup electronic system 300, and the 3D facial model constructing unit 320 constructs the 3D facial model directly according to the feature points of the facial images.

The 3D facial model moving unit 330 is coupled to the image receiving unit 310 and the 3D facial model constructing unit 320. The 3D facial model moving unit 330 changes the position and the angle of the 3D facial model according to the position and the angle of the real-time facial image. That means, the 3D facial model varies with the change of the face in real time.

The virtual makeup unit 350 is coupled to the 3D facial model constructing unit 320, the 3D facial model moving unit 330 and the makeup information receiving unit 340, and the virtual makeup unit 350 provides 3D virtual makeup to the 3D facial model according to the makeup information. More detail, the term “makeup information” herein means changes of the face area that the makeup applied, the skin color, the shape of the face, and the whole makeup scope of the face while turning or moving of the 3D facial model. In the embodiment, the virtual makeup electronic system 300 further includes a lighting information receiving unit 380 which is coupled to the virtual makeup unit 350. The lighting information receiving unit 380 receives lighting information, and the virtual makeup unit 350 adjusts the luminosity and the hue of the 3D virtual makeup according to the lighting information.

The data processing unit 360 is coupled to the image receiving unit 310 and the virtual makeup unit 350, and the data processing unit 360 converts the 3D virtual makeup to the 2D virtual makeup according to the position and the angle of the real-time facial image, and the data processing unit 360 combines the real-time facial image and the 2D virtual makeup to generate an output image. In the embodiment, the 2D virtual makeup of the output image matches with the angle and the position of the real-time facial image, which makes the 2D virtual makeup look like the reality.

In sum, the method of applying virtual makeup and the electronic device having the virtual makeup electronic system construct the 3D facial model via the facial images of different angles, and the 3D facial model varies with the face in real time. The processing unit provides the 3D virtual makeup to the 3D facial model, and the processing unit converts the 3D virtual makeup to the 2D virtual makeup according to the position and the angle of the real-time facial image (such as the angle between the image capture module and the face). The position, the shape, the size and the angle of the 2D virtual makeup change with the varying of the real-time facial image (the face is in moving or turning). The real-time facial image and the 2D virtual makeup are combined to generate the output image. The display module displays the output image. Consequently, even if the face turns to some angles where the feature points of the real-time facial image are different from that of the frontal face (for example, when the face turns 60°, the size and the distance of the eyes are different from that of the frontal face) or part of the feature points are covered, the output image still has the 2D virtual makeup which is similar to the realistic makeup, and the output image looks more natural.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. A method of applying virtual makeup, cooperating with an electronic device having a virtual makeup electronic system, the method of applying virtual makeup including:
obtaining a plurality of facial images of different angles of a face to construct a three dimensional (3D) facial model;
recording a real-time facial image of the face, wherein the 3D facial model varies with the face in real time according to a position and an angle of the real-time facial image;
providing 3D virtual makeup to the 3D facial model;
converting the 3D virtual makeup to two dimension (2D) virtual makeup according to the position and the angle of the real-time facial image;
combining the real-time facial image and the 2D virtual makeup to generate an output image; and
displaying the output image.

2. The method of applying virtual makeup according to claim 1, wherein the step of obtaining the facial images of different angles of the face to construct the 3D facial model further includes:
constructing the 3D facial model according to a plurality of feature points of the facial images, wherein the feature points include facial characters.

3. The method of applying virtual makeup according to claim 1, wherein the step of obtaining the facial images of different angles of the face to construct the 3D facial model further includes:
providing a 3D facial model database and selecting a most similar model sample in the 3D facial model database according to a plurality of the feature points of the facial images to construct the 3D facial model.

4. The method of applying virtual makeup according to claim 1, wherein the step of recording the real-time facial image of the face, and the 3D facial model varies with the face in real time according to the position and the angle of the real-time facial image further includes:
adjusting the position and the angle of the 3D facial model according to the plurality of feature points of the real-time facial image in real time.

5. The method of applying virtual makeup according to claim 1, further comprising:
detecting lighting information around the face and adjusting luminosity and hue of the 3D virtual makeup according to the lighting information.

6. A virtual makeup electronic system, applied to an electronic device, wherein the virtual makeup electronic system includes:
an image receiving unit, wherein the image receiving unit receives a plurality of facial images of different angles of a face and a real-time facial image of the face;
a 3D facial model constructing unit, coupled to the image receiving unit, wherein the 3D facial model constructing unit constructs a 3D facial model via the facial images;
a 3D facial model moving unit, coupled to the image receiving unit and the 3D facial model constructing unit, wherein the 3D facial model moving unit changes a position and an angle of the 3D facial model according to a position an angle of the real-time facial image;
a makeup information receiving unit, wherein the makeup information receiving unit receives makeup information;
a virtual makeup unit, coupled to the 3D facial model constructing unit, the 3D facial model moving unit and the makeup information receiving unit, wherein the virtual makeup unit provides 3D virtual makeup to the 3D facial model according to the makeup information; and
a data processing unit, coupled to the image receiving unit and the virtual makeup unit, wherein the data processing unit converts the 3D virtual makeup to 2D virtual makeup according to the position and the angle of the real-time facial image, and the real-time facial image and the 2D virtual makeup are combined to generate an output image.

7. The virtual makeup electronic system according to claim 6, further comprising:
a 3D facial model database, coupled to the 3D facial model constructing unit, wherein the 3D facial model constructing unit selects a most similar model sample in the 3D facial model database according to a plurality of feature points of the facial images to construct the 3D facial model.

8. The virtual makeup electronic system according to claim 6, further comprising:
a lighting information receiving unit, coupled to the virtual makeup unit, wherein the lighting information receiving unit receives lighting information, and the virtual makeup unit adjust luminosity and hue of the 3D virtual makeup according to the lighting information.

9. An electronic device having the virtual makeup electronic system, comprising:
an image capture module, wherein the image capture module captures a real-time facial image of a face;
a processing module, electrically connected to the image capture module, wherein the processing module constructs a 3D facial model via a plurality of facial images of the face of different angles, the processing module makes the 3D facial model vary with the face in real time according to the real-time facial image, the processing module provides 3D virtual makeup to the 3D facial model according to a position and an angle of the real-time facial image, and the processing module converts the 3D virtual makeup to 2D virtual makeup and combines the real-time facial image and the 2D virtual makeup to generate an output image; and
a display screen, electrically connected to the processing module, wherein the display screen displays the output image.

10. The electronic device having the virtual makeup electronic system according to claim 9, further comprising:
a storage module, wherein the storage module is electrically connected to the processing module to store the 3D facial model.

11. The electronic device having the virtual makeup electronic system according to claim 10, wherein a 3D facial model database is further comprised in the storage module, and the processing module selects a most similar model sample in the 3D facial model database according to a plurality of feature points of the facial images to construct the 3D facial model.

12. The electronic device having the virtual makeup electronic system according to claim 9, further comprising:
a sensor module, electrically connected to the processing module, wherein the sensor module detects lighting information around the face, and the processing module adjusts luminosity and hue of the 3D virtual makeup according to the lighting information.

13. The electronic device having the virtual makeup electronic system according to claim 9, wherein the image capture module is a 2D image capture module or a 3D image capture module.
